(19) United States
(12) Patent Application Publication
(10) Pub. No.: US 2009/0143987 A1
(43) Pub. Date: Jun. 4, 2009

(54) METHOD AND SYSTEM FOR PREDICTING THE IMPACT BETWEEN A VEHICLE AND A PEDESTRIAN

(75) Inventors: Julien Bect, Mandelieu (FR); Christophe Wakim, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, Boulogne-Billancourt (FR)

(21) Appl. No.: 12/064,201

(22) PCT Filed: Jul. 10, 2006
(86) PCT No.: PCT/FR06/50695

§ 371 Date: Oct. 20, 2008

(30) Foreign Application Priority Data
Aug. 19, 2005 (FR) 0508631

(51) Int. Cl. G08G 1/16

(52) U.S. Cl. 701/301; 701/300

(57) ABSTRACT

A method predicting impact between a vehicle and a detected moving pedestrian, generating N particles representing trajectory pairs of the vehicle and the pedestrian according to a Monte Carlo method, and then evaluating the outcome of each particle so that the space of states of each particle is split into areas of varying significance depending on its present kinematic state and so that in the case of a predicted non-impact, the relationship between the significance of the particle at the present instant and its significance at the preceding instant is calculated to decide, in a case of a particle whose significance increases, to reduce it to an integer greater than 1, of particles each affected by a new weight and, in a case of a particle whose significance decreases, randomly eliminating it according to the significance relationship, its probability to endure being equal to the relationship of significance, the estimation of the probability of the predicted impact being obtained by statistics on the outcome of N particles.

The present invention relates to a method of predicting impact between a vehicle and a moving pedestrian, with the aim of improving the safety of pedestrians. It is more particularly applied in a system for protecting pedestrians of pre-crash type, which triggers suitable counter-measures such as emergency braking or a change of trajectory of the vehicle, a few moments before the impact with a pedestrian detected in the front vicinity of the vehicle. It also relates to an onboard system for implementing said method.

A pedestrian pre-crash system must be able to predict a vehicle-pedestrian impact with estimation of a risk of impact in a very short time span, between a few hundreds of milliseconds and a second, so as to trigger suitable reactions to avoid the predicted impact or limit its consequences.

This system receives information about the dynamic state of the vehicle, its engine revs, the position of the driver's various controls, information about the pedestrian or pedestrians detected, such as their dimension, their position or their speed for example, so as to estimate the risk that a vehicle-pedestrian impact occurs between two instants t₀ and t₀+ΔT.

As described in French patent application FR 2 864 673, relating to an impact prediction method of probabilistic type, it is necessary to generate the future trajectories of the vehicle and pedestrian on the basis of realistic and suitable models, then at each timestep increment, it is necessary to test whether or not there is impact by assuming that each state variable can take a set of values with which probabilities are associated so as to quantify the risks. This quantification can be done by Monte Carlo simulations, which are for example described in an article by E. A. JOHNSON, L. A. BERGMAN and B. F. SPENCER, entitled “Intelligent Monte Carlo Simulation and Discrepancy Sensitivity” and published with the following publication references: P. D. Spanos (ed.), Computational Stochastic Mechanics, Balkema, Rotterdam, 1999, 31-39.

This quantification consists:
in drawing an initial number N of particles corresponding to the pairs of vehicle and pedestrian trajectories having as origin the situation of which one wishes to evaluate the impact characteristics, the state of the particles depending on the measurements and estimations delivered by the sensor for detecting obstacles of the system,
in predicting the trajectories of the particles,
then in testing, for each discrete timestep, whether there is impact between the vehicle and each particle corresponding to the pedestrian.

In the case of simple Monte Carlo simulations, each of the N particles i corresponding to a pair of trajectories, is assigned a weight p=1/N, uniform over the whole set of particles, throughout the duration ΔT of the simulation. To estimate the probability of impact P_{impact} between the instants t₀ and t₀+ΔT, it suffices to sum the weights assigned to those particles for which the simulation terminates in an impact. The time before impact can be estimated by taking the mean of the times before impact of the trajectories which terminate in an impact. The uncertainties assigned to the evolution of the trajectory of the pedestrian are quantified by the distribution of the probabilities. A large number of scenarios are created during the simulation with the aid of a pseudo-random number generator, then the outcome of each pair of trajectories, or particle, is evaluated. In the event of impact, the characteristics are stored, then the application of statistics on the outcomes of the set of trajectories makes it possible to estimate the distribution of the various data describing the impact, that is to say the time before impact, the impact zone, the impact speed and the probability of impact.

The drawback of a current probabilistic impact prediction procedure using Monte Carlo simulation is to do with the calculation power required, which prevents its real-time use, unless the accuracy of the results is sacrificed. Moreover, with the model of pedestrian trajectories that was developed in the prior art cited, based on four discrete states, with a number N of trajectories greater than 100, such a prediction method cannot ensure real-time performance.

The aim of the invention is to propose improved prediction of impact between a vehicle and a pedestrian of probabilistic type.

For this purpose, a first subject of the invention is a method of predicting impact between a vehicle and a detected moving pedestrian, comprising a phase of generating N particles representing pairs of vehicle and pedestrian trajectories, having as origin the situation whose impact characteristics are to be evaluated, on the basis of a vehicle model and of a pedestrian model with several discrete states, as well as on the basis of the initial positions of the vehicle and of the pedestrian and of information about their respective kinematic states, followed by a phase of evaluating the outcome of each particle, characterized in that the particle state space is sliced into zones of variable significance defined as a numerical value directly related to the interest accorded to each particle and dependent on its current kinematic state, and in that in the event of predicted non-impact for a tested particle, the method calculates the ratio of the significance of the particle at the present instant to its significance at the previous instant so as to decide, in the case of a particle whose significance is increasing, to scale it down into an integer number n, greater than 1, of particles each assigned a new weight and, in the case of a particle whose significance decreases, to randomly eliminate it, its probability of survival being equal to the significance ratio, the estimation of the probability of impact and characteristics of said predicted impact being obtained thereafter by the application of statistics on the outcomes of the set of N particles.

Advantageously, according to the invention, the vehicle-pedestrian impact prediction calculation allows a result in real time.

According to another characteristic of the method of predicting impact, the slicing of the space in front of the vehicle, according to the instantaneous orthonormal reference frame tied to the front of the vehicle, is carried out on the basis of the relative distance between the vehicle and the pedestrian, defining significance zones in the form of circular annuli, centered on the middle of the bumper of the vehicle and whose diameter is the bumper.

According to another characteristic of the method of predicting impact, the slicing of the space in front of the vehicle, according to the instantaneous orthonormal reference frame tied to the front of the vehicle, is carried out on the basis of the longitudinal component of the relative speed due to the vehicle and of its lateral component which is regarded as that of the pedestrian, defining significance zones in the form of ellipses, centered on the middle of the bumper of the vehicle, with semi minor axis on the ordinate axis and with semi major axis on the abscissa axis.

According to another characteristic of the method of predicting impact, the slicing of the space in front of the vehicle, according to the instantaneous orthonormal reference frame tied to the front of the vehicle, is carried out according to the value of the lifetime of the particle, or time before overtaking, necessary so that the longitudinal position of the pedestrian is level with the front face of the vehicle, at each instant tᵢ of the simulation, and the shorter this lifetime, the higher the significance of the zone, only the longitudinal position of the pedestrian and his speed then being taken into account, defining significance zones in the form of bands parallel to the ordinate axis.

According to another characteristic of the method of predicting impact, the slicing of the space in front of the vehicle, according to the instantaneous orthonormal reference frame tied to the front of the vehicle, is carried out by taking account of the angular position of the pedestrian in the plane defined by the axes Ox and Oy of the reference frame of the vehicle, obtained with the ratio of his lateral position y to his longitudinal position x, defining significance zones in the form of sectors of origin 0, making with respect to the abscissa axis Ox, an angle θ equal to the arctangent of the ratio of these two positions:

θ=arctan(y/x).

According to another characteristic of the method of predicting impact, the slicing of the space in front of the vehicle, according to the instantaneous orthonormal reference frame tied to the front of the vehicle, is carried out on the basis of the direction of the relative speed of the pedestrian with respect to the vehicle, obtained either by the arc tangent of the ratio of his longitudinal speed to his lateral speed, or by the arc tangent of the ratio of the speed of the pedestrian to that of the vehicle:

α=arctan(V_{ped}/Vᵥₑₕ)

defining significance zones in the form of isosceles triangles, of height on the abscissa axis Ox and of base on the ordinate axis Oy, and of angle α at the vertex defined by the arc tangent of the ratio of the speed of the pedestrian to that of the vehicle:

α=arctan(V_{ped}/Vᵥₑₕ).

According to another characteristic, the method of predicting impact comprises the following steps:
the determination of the initial kinematic state of the vehicle and of the pedestrian, followed by the generation of a number (Nᵢ) of particles, each assigned a weight and corresponding to a pair of simulated trajectories for the vehicle and the pedestrian at the instant (tᵢ), and for each of which a kinematic state is simulated which is thereafter compared with the initial state,
in the case where there is impact, the estimation and the storage of the characteristics of the impact, before eliminating the particle k considered and continuing the simulation with the following particle k+1 up to the Nᵢ^{th} particle,
in the case of an exit from the impact zone, without there having been any impact, the storage of the characteristics of the trajectory k before its elimination and the continuation of the simulation with the following particle k+1 up to the Nᵢ^{th} particle,
in the case where there is no impact, the verification that the simulation has not terminated, on the other hand if the simulation has terminated without impact, it is continued again with the storage of the last trajectory and its elimination,
in the case where there is no impact, the particle k having survived, the calculation of the ratio β_{i,k} of the value of the significance associated with its new state at the instant tᵢ in the state space to its value at the previous instant tᵢ₋₁, which is thereafter compared with 1:
if β_{i,k} is equal to 1, this trajectory k does not exhibit a growing interest and the method passes to the following simulated trajectory k+1,
if β_{i,k} is less than 1, the random elimination by a step of “Russian roulette” of the particle which is of no interest, with allocation of a new weight if it survives,
if β_{i,k} is greater than 1, the scaledown by a step of “splitting” of the particle considered to be significant into a number n(k) of new particles each assigned a weight, different from that of the significant particle k, which particles will be processed at the following instant tᵢ₊₁,
after the verification that all the Nᵢ particles have been processed, the estimation of the probability of impact and characteristics of the possible impact on the basis of the statistics on the weights stored.

A second subject of the invention is a system for implementing the method of predicting impact between a vehicle and a detected moving pedestrian, carried on board the vehicle, comprising means for detecting obstacles in the environment of the vehicle, associated with means for estimating their position and their speed, linked to vehicle/pedestrian impact prediction means, which additionally receive information about the dynamics of the vehicle equipped with said system on the part of sensors connected to the controls of the vehicle, these impact prediction means associating with each detected obstacle a probability of impact, a time before impact, an envisaged impact zone and possibly a speed on impact, which they dispatch to means for selecting the optimal counter-measure that the system must apply in an emergency to protect the pinpointed pedestrian.

Other characteristics and advantages of the invention will be apparent on reading the description of the method, illustrated by the following figures which are:

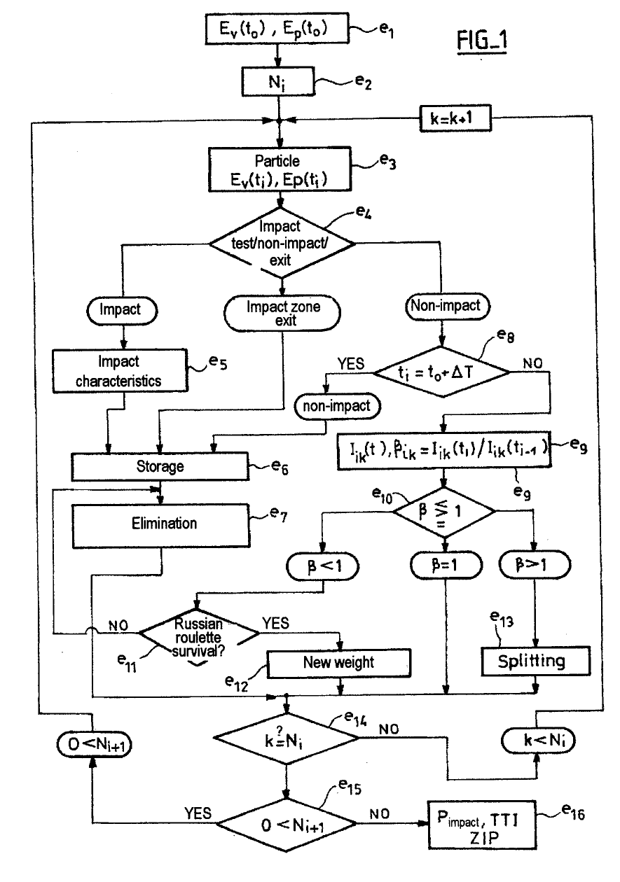

FIG. 1: an exemplary nonlimiting flowchart of the vehicle-pedestrian impact prediction method,

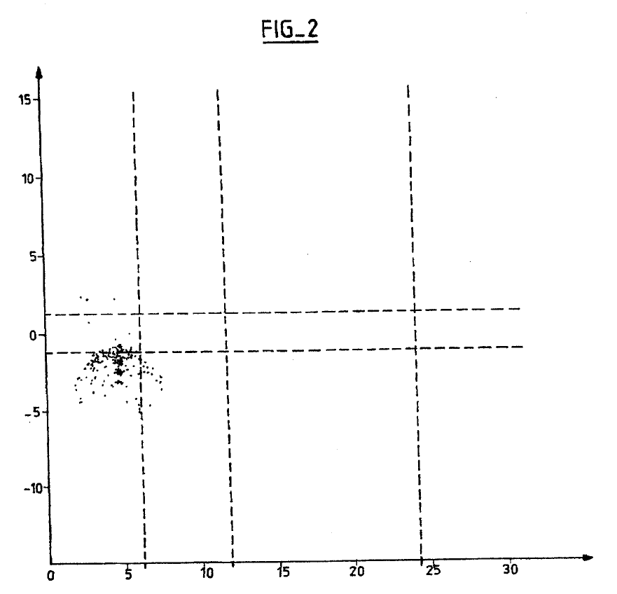

FIG. 2: a nonlimiting example of Monte Carlo simulation, with a number N particles, in the reference frame of the vehicle,

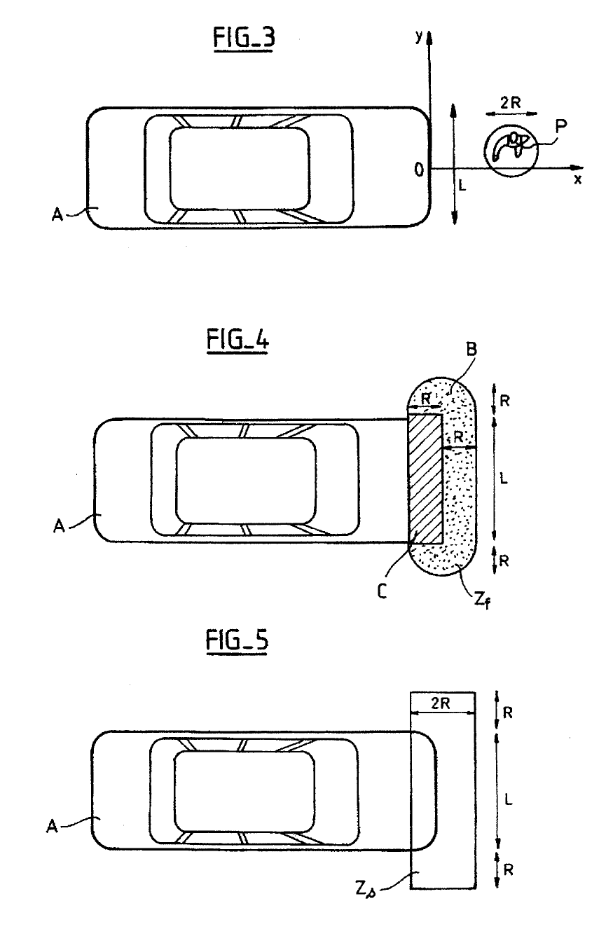

FIG. 3: a diagrammatic view from above of a vehicle and a pedestrian, endowed with an orthonormal reference frame,

FIG. 4: an exemplary geometric modelling of a front impact between a vehicle and a pedestrian,

FIG. 5: a variant definition of the impact zone,

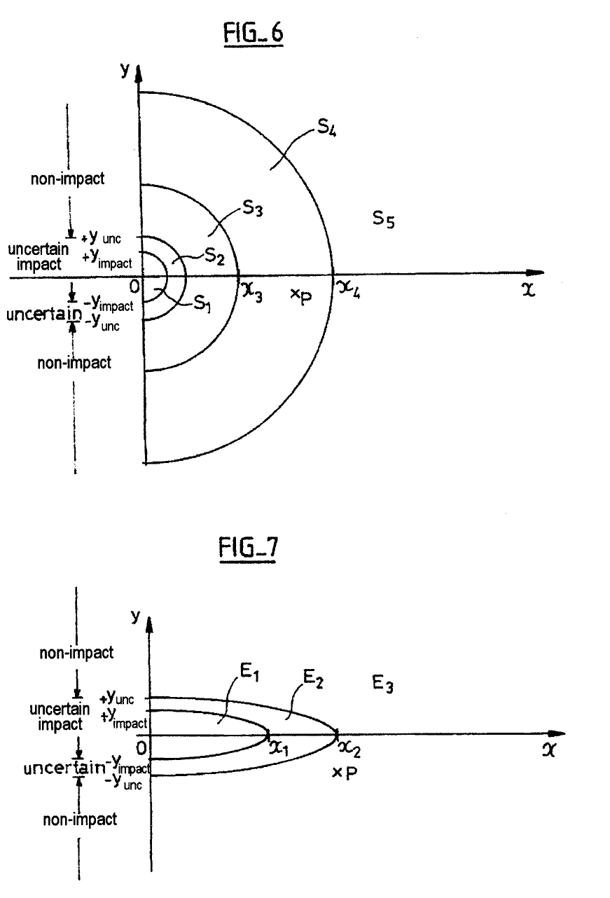

FIGS. 6 to 11: nonlimiting examples of significance zones.

The method of predicting impact between a vehicle and a moving pedestrian according to the invention is of probabilistic type, each state variable of the pedestrian trajectory model being able to take a set of values with which probabilities are associated, thereby making it possible to quantify the risks. The aim of the method is to estimate, for a given vehicle-pedestrian situation, the probability of impact between the present instant t₀ and the limit instant of prediction t₀+ΔT, ΔT being the temporal prediction horizon, and to estimate the characteristics of the impact, i.e. the time before impact, the impact zone and the impact speed in particular.

According to the invention, the method takes account of the fact that the trajectories of the various particles do not all exhibit the same interest. For the prediction of vehicle-pedestrian impact, the particles which are situated far from the impact zone, this corresponding to a pedestrian crossing in front of the vehicle at a distance of greater than 30 metres for example, exhibit much less interest than the particles which are situated in the vicinity of the impact zone. This is why, the quantification of the risks being done by trajectory simulations of Monte Carlo type, the method according to the invention uses variance reduction procedures, such as “splitting” or “Russian roulette” consisting in applying a significance sampling to the states so as to improve the performance of the simulation.

The method consists first of all in generating an initial number N of particles, each corresponding to a pair of trajectories of the vehicle and of the pedestrian, the state of the particles depending on the measurements and estimations delivered by the sensor for detecting pedestrians of the system fitted to the vehicle, then in processing the N particles by testing, at each instant for each particle, whether there is impact between the vehicle and the pedestrian. Thereafter, the method evaluates the outcome of each pair of trajectories and, on the one hand, stores the number of particles liable to experience an impact, together with their weight, their position and speed characteristics, and on the other hand, allocates in the event that non-impact is predicted, to each particle, at each instant, a numerical value directly related to the interest accorded to this particle and called the “significance”; it depends on the present kinematic state (position, speed, etc.) of the particle. It charts the evolution of the significance of said particle for calculating its final weight which will depend on the significance zones that it will have followed. Finally, to estimate the probability of impact over the duration of the simulation, the method sums the weights of those particles for which the simulation terminates in an impact and estimates the characteristics of the impact predicted on the basis of statistics, such as the time before impact, the impact zone or the impact speed.

Thus, according to a characteristic of the invention, in the case where there is no impact, the method calculates the significance ratio β of the present state of the particle to its state at the previous instant.

If the ratio of the significance of the present state to that of the previous state is equal to 1, the method takes interest in the following particle.

If the present state of the pedestrian is more significant than his previous state, the method will carry out a step of “splitting”, that is to say of scaledown of the particle whose significance is increasing. It is divided into an integer number n, greater than 1, of new particles, each new particle being assigned the initial particle's weight divided by n, this new weight serving in the calculation of the probability of impact. This number n is an increasing function of the significance ratio β of the particle considered.

If the simulated present state of the pedestrian is less significant than his previous state, the method carries out a step of “Russian roulette”, that is to say of random elimination of said particle considered to be of no interest. It has a probability of survival p equal to the significance ratio β. Two cases may arise: it survives and its weight, serving for the probability of impact, is then multiplied by the inverse of the significance ratio β, or else it dies, its weight becomes zero and this trajectory is no longer used.

In order not to introduce an additional bias through these two steps, each particle is assigned a weight which determines its contribution to the total mass of the cluster that it constitutes together with the others, that is to say to the final calculation of the expectation of impact. Sometimes, it is necessary to resample the cluster so that the number of particles is kept bounded, when the number of particles N(t) is greater than the maximum number Nₘₐₓ, defined as a function of the performance of the computer. It is typically possible to choose the value 256.

An exemplary flowchart of the vehicle-pedestrian impact prediction method is described in regard to FIG. 1, which comprises a first step e1) of determining the initial kinematic state of the vehicle Eᵥ(t₀) and of the pedestrian Eₚ(t₀), that is to say their respective positions and their speeds, at the initial instant t₀ of the simulation, followed by a second step e2) of generating a number Nᵢ of particles, each assigned a weight pᵢ, corresponding to Nᵢ pairs of trajectories simulated for the vehicle and the pedestrian, at the instant tᵢ=tᵢ₋₁+δt, δt being the sampling timestep, knowing their states at tᵢ₋₁.

For each particle k of the Nᵢ particles simulated at the instant tᵢ, the method generates a simulated state for the vehicle Eᵥ(tᵢ) and a simulated state Eₚ(tᵢ) for the pedestrian in step e3) so as to undertake, at the following step e4), a test for comparing these two states to determine whether, over the interval [tᵢ₋₁, tᵢ] there is impact and at which instant, or no impact, or else whether the pedestrian has exited the impact zone defined between the pedestrian and the front face of the vehicle. Definitions of this impact zone are proposed in regard to subsequent FIGS. 3, 4 and 5.

In the case where there is impact, the method carries out a step e5) of estimating the characteristics of the impact, in particular the instant of impact predicted, the impact zone and the probability of impact, then it stores them in step e6), before eliminating the particle k considered in step e7) and continues the simulation with the following particle k+1 up to the Nᵢ^{th} particle.

In the case of an exit from the impact zone, without there having been any impact, the method also stores the characteristics of the trajectory k in step e6) before eliminating it in step e7) and continues the simulation with the following particle k+1 up to the Nᵢ^{th} particle, as in the previous case.

In the case where there is no impact, the method verifies in step e8) that the simulation has not terminated, therefore that the instant tᵢ of the simulation is not equal to t₀+ΔT, ΔT being the limit of the simulation. If the simulation has terminated without impact, it is continued again with the storage of the last trajectory and its elimination, as in the two previous cases.

In the case where there is no impact and the simulation has not terminated, the particle k has therefore survived and the method calculates in step e9) the value of the significance I_{i,k} associated with its new state at the instant tᵢ in the state space, as well as the ratio β_{i,k} of the significance of this particle k at the instant tᵢ to its value at the previous instant tᵢ₋₁. This ratio β_{i,k} makes it possible to measure the evolution of the significance of the particle k considered, this is why its value is thereafter compared with 1 in step e10). If the ratio β_{i,k} is equal to 1, this trajectory does not exhibit a growing interest and the method passes to the following simulated trajectory k+1. If the ratio β_{i,k} is less than 1, the method applies a step e11) of “Russian roulette” strategy randomly eliminating the particle which is of no interest. Thus, either the particle k is eliminated in step e7), or it survives and a new weight pₖ is assigned to it in step e12).

If the ratio β_{i,k} is greater than 1, the method applies a step e13) of “splitting” strategy which scales down the particle considered to be significant into a number n(k) of new particles each assigned a weight, different from that of the significant particle k, which particles will be processed subsequently at the following instant tᵢ₊₁. A new sampling step may be necessary so as to retain a reasonable number of particles.

The particles arising from the “Russian roulette” or “splitting” strategies will be processed at the next timestep and those which terminate in an impact will be stored and used for the statistics. Their weights will be stored until they are eliminated.

When the simulation verifies in step e14) that it has considered all the Nᵢ particles, it verifies that there will be particles to be processed at the next timestep, therefore that the number Nᵢ₊₁ is positive, in step e15). Specifically, if for example all the particles culminate in impacts at the instant tᵢ or at previous instants, there will no longer be any particles to be processed at the next timestep tᵢ₊₁, therefore there will no longer be any need to simulate a trajectory. Thereafter, the method estimates the probability of impact and the characteristics of the possible impact on the basis of the statistics on the results stored, in the final step e16). To estimate the probability of impact P_{impact} between the instants t₀ and t₀+ΔT, the method sums the weights assigned to those particles for which the simulation terminates in an impact.

FIG. 2 is an exemplary Monte Carlo simulation, with a number N of particles, of the order of 250, in the reference frame of the vehicle, whose origin 0 is the center of the impact zone in the middle of the bumper of the vehicle, the abscissa axis Ox is directed in the plane of the road towards the front of the vehicle and the ordinate axis Oy, also included in the plane of the road, is directed from right to left of the vehicle, as shown by FIG. 3 which is a diagrammatic view from above of a vehicle A and of a pedestrian P. For reasons of simplicity and reproducibility, the trajectory predictions are made in the instantaneous orthonormal reference frame of the vehicle and the impact tests make it necessary to transpose the position of the pedestrian into this reference frame of the front face of the vehicle. Concerning the relative trajectory of the pedestrian with respect to the vehicle, the speed of the latter is generally large compared with that of the pedestrian, and the method considers that, in this reference frame of the front face of the vehicle, the abscissa of the pedestrian is always decreasing over time.

The outcome of a pedestrian trajectory, in the relative reference frame of the vehicle may be of three kinds:
there is impact between the vehicle and the pedestrian, at the instant t_{impact} and the method stops the simulation for the particle concerned;
there is no impact since the pedestrian passes behind the impact zone from the instant tₑₓᵢₜ onwards, so that the method stops the simulation at this instant since the pedestrian is no longer at risk of being hit, his abscissa becoming negative;
there is no impact but the abscissa of the relative position of the pedestrian remains positive in the reference frame of the vehicle, likewise the method continues the phase of simulating the trajectory of the pedestrian up to its limit ΔT.

The duration ΔT of an impact prediction therefore depends on the proportion of cases belonging to these three types of outcomes of trajectories. The durations of trajectories ending in the first two outcomes, with abscissa close to 0, are substantially equal if it is accepted that the relative longitudinal movement of the pedestrian along the axis Ox is essentially due to the displacement of the vehicle. In these two cases, the lifetime τ of the particle is dependent respectively on the instants t_{impact} and tₑₓᵢₜ, which are equal to the quotient of the relative longitudinal distance x and the norm of the speed Vᵥₑₕ of the vehicle:

τ=X/Vᵥₑₕ

The smaller the value of τ, the larger the number N of particles may be, for equal overall calculation time.

For the third case in which the calculation of the trajectory is done over the whole of the duration ΔT, it does not require any calculation with a finer timestep δt and is therefore not expensive in terms of calculation time.

The invention relates solely to the prediction of front impacts between a pedestrian and the front face of the vehicle which is modelled by a segment having the width L of the vehicle as dimension, as shown in FIG. 3. The pedestrian P is regarded as a cylinder of diameter 2R equal to the maximum width of an average pedestrian and of the same height as this average pedestrian, so that it is possible to define a vehicle/pedestrian impact zone corresponding to an intersection between a segment representative of the front face of the vehicle A and a disk representative of the envelope of the pedestrian P, as shown by FIG. 4 which is an exemplary geometric modelling of a front impact between a vehicle and a pedestrian. For example, the diameter 2R is equal to 60 cm.

Three situations are depicted:
there is impact when the front of the vehicle overlaps the largest part of the pedestrian (striped zone C),
there is no impact when there is no overlap between the model of the pedestrian and the front face,
there is impact/non-impact ambiguity when less than half of the circle encompassing the pedestrian is cut by the front face (dotted zone B).

Inside the ambiguity zone, it is possible to define a function, of the gravity of the impact type, which would pass continuously from 0 (no impact) to 1. The concept of impact would then correspond to the overstepping of a threshold to be defined. This possibility of weighting the significance or the gravity of an impact may turn out to be beneficial when evaluating real systems: a priori, to predict an impact taking place in the middle of the front face of the vehicle is simpler than a front impact taking place on one of the left or right edges.

Two variant definitions of the impact zone are represented in FIGS. 5 and 4, corresponding to the description respectively of the simple impact zone and of the “fine” impact zone. The simple impact zone Z_{S}, with no ambiguity zone, is a rectangle of width equal to 2R and of length equal to the sum of the width L of the vehicle and of the diameter 2R of the model of the pedestrian. The “fine” impact zone Z_{f} is the association of a rectangle, of length L and of width 2R, and of two half-circles of radius R at each end.

The test for predicting impact between a vehicle and a pedestrian consists in comparing the probability of impact calculated to a threshold, generally lying between 70 and 95%. If p is the probability of impact, the variance of the estimate of this probability by conventional Monte Carlo simulation equals p.(1−p)/N, N being the number of particles drawn and this variance in the vicinity of the detection threshold is relatively significant. According to an essential characteristic of the invention, the method defines significance regions or zones such that, when a particle enters a higher significance zone, it is scaled down, but conversely when it enters a lower significance region, it can be randomly eliminated by “Russian roulette”. Various criteria regarding the situations between a vehicle and a pedestrian, in the reference frame of the front face, lead to various slicings of the significance zones.

FIGS. 6 to 11 are nonlimiting examples of significance zones in the case of a uniform rectilinear movement of the vehicle, the space in front of the vehicle being sliced for example according to three zones related to the forecast gravity of the impact: there is impact, non-impact, or impact is uncertain, inter alia.

The example of FIG. 6 shows a slicing of the space in front of the vehicle, according to the instantaneous orthonormal reference frame tied to the front of the vehicle, carried out on the basis of the relative distance between the vehicle and the pedestrian only without taking account of their relative speed, thereby giving rise to zones in the form of circular annuli, centered on the middle of the bumper of the vehicle and whose diameter consists of the bumper. The first semi-circular zone S₁ lying between the ordinates +Y_{impact} and −Y_{impact} corresponding to the two ends of the bumper of the vehicle, exhibits a high significance I₁, since the impact y is certain. The second annular zone S₂, following the first S₁ and lying between the ordinates +_{Yunc} and −_{Yunc} corresponding to an uncertain impact, exhibits a maximum significance I₂. The third annular zone S₃, of exterior radius equal to X₃, corresponding to an abscissa of the pedestrian P equal to the product of the speed of the vehicle Vᵥₑₕ times 0.5 seconds for example (x₃=0.5*Vᵥₑₕ), exhibits a significance I₃ of less than I₁. It is also possible to define a fourth zone S₄ of still smaller significance I₄, of exterior radius equal to x₄, corresponding to an abscissa of the pedestrian equal to the product of the speed of the vehicle times 1 second (x₄=1*Vᵥₑₕ) and a fifth zone S₅ corresponding to the remainder of the half plane of the positive abscissa.

If it is assumed that the longitudinal component of the relative speed is due to the vehicle and that its lateral component is regarded as that of the pedestrian, the significance zones are sliced according to ellipses, centered on the middle of the bumper of the vehicle, as shown by FIG. 7. The first ellipse E₁ has as semi minor axis the ordinate Y_{impact} and as semi major axis the product of Y_{impact} times the ratio of the speeds of the vehicle and of the pedestrian: Y_{impact} * Vᵥₑₕ/V_{ped}. The second ellipse E₂ has as semi minor axis the ordinate Y_{unc} and as semi major axis the product of Y_{unc} times the ratio of the speeds of the vehicle and of the pedestrian: Y_{impact} * Vᵥₑₕ/V_{ped} and exhibits a maximum significance. A third zone E₃ corresponds to the remainder of the half plane of the positive abscissa.

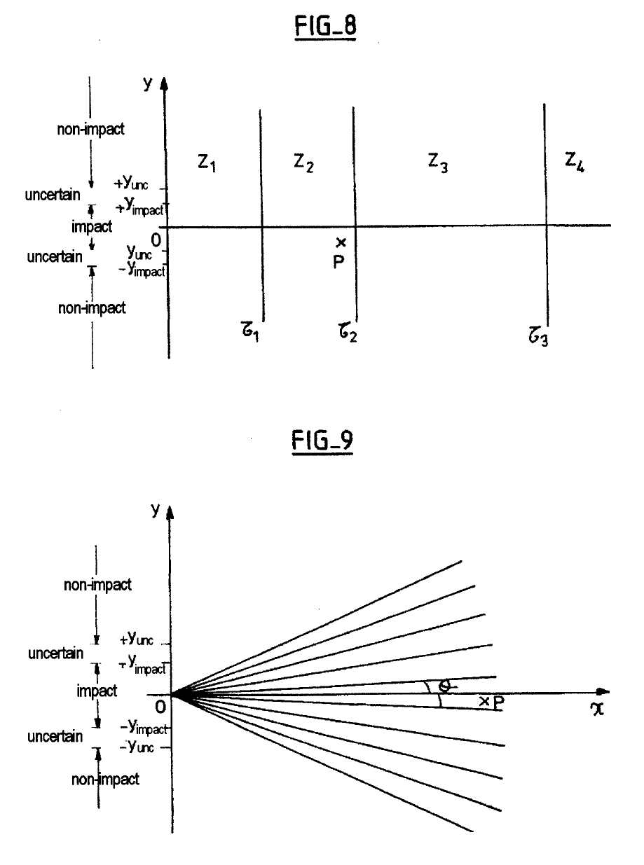

To adapt the conditions on the distance as a function of the speed, the method proposes (FIG. 8) a slicing of the space in front of the vehicle, according to the instantaneous orthonormal reference frame tied to the front of the vehicle, carried out according to the value of the lifetime τ of the particle at each instant tᵢ of the simulation. This time τ is also called the time before overtaking, necessary in order for the longitudinal position of the pedestrian to be level with the front face of the vehicle. The shorter this lifetime τ, the higher the significance of the zone. In this case, only the longitudinal position x of the pedestrian and his speed Vₚ are taken into account. Thus, in FIG. 8, the significance zones have the form of bands parallel to the ordinate axis, the zone Z₁ of higher significance corresponds to a lifetime τ₁ lying between 0 and 0.5 seconds and is situated closest to the vehicle, a second zone Z₂ of less high significance corresponds to a lifetime τ₂ lying between 0.5 and 1 second, a third zone Z₃ lies between 1 and 2 seconds of lifetime τ₃, and a last zone Z₄ corresponds to the remainder of the half plane of the positive abscissa.

In the example of FIG. 9, the slicing of the space is done by taking account of the angular position of the pedestrian in the plane defined by the axes Ox and Oy of the reference frame of the vehicle, which position is obtained with the ratio of his lateral position y to his longitudinal position x. The significance zones are defined by sectors of origin 0, making with respect to the abscissa axis Ox, an angle θ equal to the arc tangent of the ratio of these two positions: θ=arc tan(y/x). The larger the angle, the smaller the significance and a large number of sectors makes it possible to approach a continuous variation of the significance.

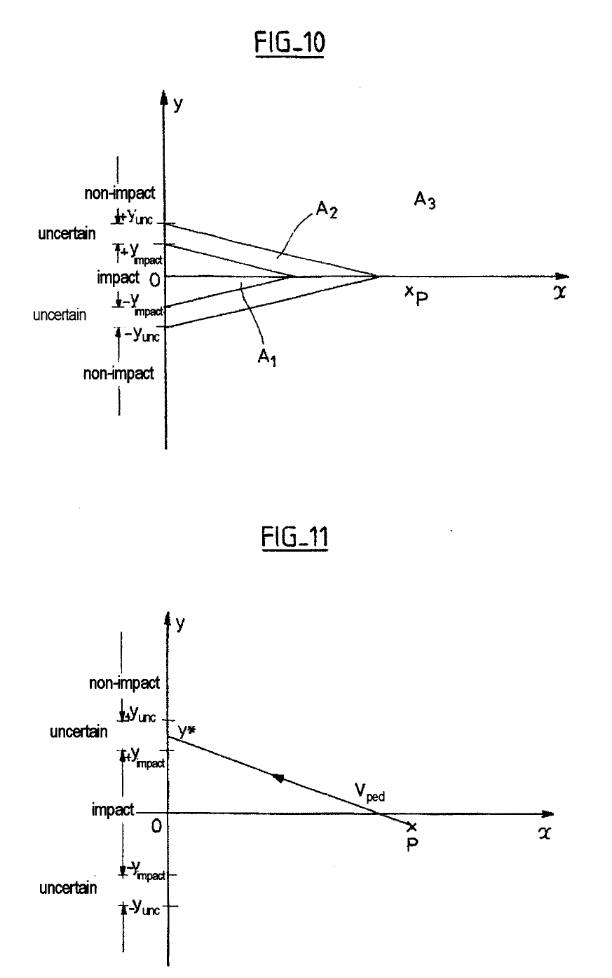

In the example of FIG. 10, the slicing of the space is done on the basis of the direction of the relative speed of the pedestrian with respect to the vehicle, obtained either by the arc tangent of the ratio of his longitudinal speed to his lateral speed, or by the arc tangent of the ratio of the speed of the pedestrian V_{ped} to that of the vehicle Vᵥₑₕ:

α=arctan(V_{ped}/Vᵥₑₕ).

The significance zones are defined by isosceles triangles, of height h₁, on the abscissa axis Ox and of base on the ordinate axis Oy and of angle α at the vertex defined by the arc tangent of the ratio of the speed of the pedestrian V_{ped} to that of the vehicle Vᵥₑₕ:

α=arctan(V_{ped}/Vᵥₑₕ).

A first zone A₁ has a base equal to 2 Y_{impact} and as height h₂ the product of Y_{impact} times the ratio of the speed of the vehicle to that of the pedestrian, making with respect to the axis Ox, an angle α defined by: α=arctan (V_{ped}/Vᵥₑₕ). Its significance I₁, is large. A second zone A₂ has a base equal to 2 Y_{unc} and as height the product Y_{unc} times the ratio of the speed of the vehicle to that of the pedestrian, and its significance is maximal. And a third zone A₃ corresponds to the remainder of the half plane of the positive abscissa, with a lower significance than that of the first zone.

These previously described criteria being valid only over some of the cases encountered, a combination of these significance slicings is preferable. For example, the method uses deterministic prediction, this amounting to simultaneously using the lifetime τ of the particle and the ordinate y* which estimates the lateral position of the pedestrian P when his longitudinal position will be zero and which is defined, as shown in FIG. 11, by:

y*=y+τ*V_{y}^{ped}

V_{y}^{ped} being the lateral speed of the pedestrian.

Three significance levels may be defined as a function of the absolute value of y*:
if |y*|<y_{impact}, the significance is high,
if y_{impact}≦|y*|≦Y_{unc}, the significance is maximal,
if Y_{unc}<|y*|, the significance is less, and lower than the first.

To carry out this method of predicting impact between a vehicle and a detected pedestrian, the implementation system, carried on board the vehicle, comprises means for detecting obstacles in the environment of the vehicle, associated with means for estimating their position and their speed, linked to vehicle/pedestrian impact prediction means, which additionally receive information about the dynamics of the vehicle equipped with said system on the part of sensors connected to the controls of the vehicle, these impact prediction means associating with each detected obstacle a probability of impact, a time before impact, an envisaged impact zone and possibly a probability of speed on impact, which they dispatch to means for selecting the optimal counter-measure that the system must apply in an emergency to protect the pinpointed pedestrian.

By virtue of the four-state pedestrian model, described in French patent application FR 03 15548, which is piecewise deterministic, when the random components of the trajectory have been obtained, the trajectory of the pedestrian, therefore his position at a given point, can be expressed in an analytical manner. This property makes it possible to substantially reduce the number of transit points to be generated over the duration ΔT of the trajectory prediction and therefore the number of impact tests to be performed. These specific features of the pedestrian model, combined with an intelligent Monte Carlo procedure with variance reduction by “splitting” or “Russian roulette”, allows real-time use, while retaining the qualities of the model which ensure excellent performance in terms of rates of correct prediction and of false alarms. Contrary to the earlier solutions, the method according to the invention requires less information, the distance of the pedestrian from the vehicle only for example, without the direction of the speed thereof in particular. This reduces the load and the power, hence the size and the cost of the dedicated electronic computer, as well as that of the associated sensors.

The impact prediction associated with the estimation of the predicted time before impact, in a system for protecting pedestrians of pre-crash type, enables the driver and/or the pedestrian to assess the gravity of the situation, otherwise counter-measures are triggered automatically. The driver and/or the pedestrian can also be alerted so that they trigger an avoidance or impact speed reduction maneuver through a change of trajectory, emergency braking or the like.

1-10. (canceled)

11. A method of predicting impact between a vehicle and a detected moving pedestrian, comprising:
generating N particles representing pairs of vehicle and pedestrian trajectories, having as an origin a situation whose impact characteristics are to be evaluated, based on a vehicle model and a pedestrian model with plural discrete states, of initial positions of the vehicle and of the pedestrian and of information about their respective kinematic states; and
evaluating an outcome of each particle,
wherein the particle state space is sliced into zones of variable significance, the significance being defined by a numerical value directly related to interest accorded to each particle and dependent on its present kinematic state, and
wherein in an event of predicted non-impact, the method further calculates the ratio of the significance of the particle at a present instant to its significance at a previous instant so as to decide, in a case of a particle whose significance is increasing, to scale it down into an integer number n, greater than 1, of particles each assigned a new weight and, in a case of a particle whose significance decreases, to eliminate it as a function of the significance ratio, its probability of survival being equal to the significance ratio, estimation of the probability of impact and characteristics of the predicted impact being obtained thereafter by application of statistics on outcomes of the set of N particles.

12. The method of predicting impact as claimed in claim 11, wherein the slicing of the space into significance zones in front of the vehicle, according to an instantaneous orthonormal reference frame tied to the front of the vehicle, is carried out based on relative distance between the vehicle and the pedestrian, defining the significance zones in a form of circular annuli, centered on the middle of a bumper of the vehicle and whose diameter is the bumper.

13. The method of predicting impact as claimed in claim 11, wherein the slicing of the space into significance zones in front of the vehicle, according to an instantaneous orthonormal reference frame tied to the front of the vehicle, is carried out based on a longitudinal component of relative speed due to the vehicle and its lateral component, which is regarded as that of the pedestrian, defining the significance zones in a form of ellipses, centered on the middle of a bumper of the vehicle, with semi minor axis on the ordinate axis and with semi major axis on the abscissa axis.

14. The method of predicting impact as claimed in claim 13, wherein the slicing of the space into significance zones in front of the vehicle, according to an instantaneous orthonormal reference frame tied to the front of the vehicle, is carried out according to a value of lifetime of the particle, or time before overtaking, necessary so that longitudinal position of the pedestrian is level with the front face of the vehicle, at each instant of the simulation, and wherein the shorter the lifetime, the higher the significance of the zone, only the longitudinal position of the pedestrian and of the pedestrian speed being then taken into account, defining the significance zones in a form of bands parallel to ordinate axis.

15. The method of predicting impact as claimed in claim 11, wherein the slicing of the space into significance zones in front of the vehicle, according to an instantaneous orthonormal reference frame tied to the front of the vehicle, is carried out by taking account of angular position of the pedestrian in the plane defined by axes of the reference frame of the vehicle, obtained with the ratio of lateral position (y) of the pedestrian to longitudinal position (x) of the pedestrian, defining the significance zones in a form of sectors of origin, making with respect to the abscissa axis, an angle (θ) equal to the arc tangent of the ratio of these two positions:
θ=arctan(y/x).

16. The method of predicting impact as claimed in claim 11, wherein the slicing of the space into significance zones in front of the vehicle, according to an instantaneous orthonormal reference frame tied to the front of the vehicle, is carried out based on a direction of relative speed of the pedestrian with respect to the vehicle, obtained either by arc tangent of ratio of longitudinal speed to lateral speed of the pedestrian, or by arc tangent of ratio of speed of the pedestrian (V_{ped}) to that of the vehicle (Vᵥₑₕ):
α=arctan(V_{ped}/Vᵥₑₕ)
defining the significance zones in a form of isosceles triangles, of height on an abscissa axis and of base on an ordinate axis, and of angle (α) at the vertex defined by the arc tangent of the ratio of the speed of the pedestrian to that of the vehicle:
α=arctan(V_{ped}/Vᵥₑₕ).

17. The method of predicting impact as claimed in claim 11, wherein the slicing of the space into significance zones ahead of the vehicle, according to an instantaneous orthonormal reference frame tied to the front of the vehicle, is carried out based on deterministic prediction, which simultaneously uses a lifetime (τ) of the particle and the ordinate (y*), which estimates the lateral position (y) of the pedestrian when the longitudinal position of the pedestrian will be zero and which is defined, with the lateral speed of the pedestrian (V_{y}^{ped}), by:
y*=y+τ*V_{y}^{ped}
three significance levels being defined as a function of absolute value of y*:
if |y*|<y_{impact}, the significance is high,
if y_{impact}≦|y*|≦Y_{unc}, the significance is maximal,
if Y_{unc}<|y*|, the significance is less, and lower than the first.

18. The method of predicting impact as claimed in claim 11, further comprising:
determining initial kinematic state of the vehicle [Eᵥ(t₀)] and of the pedestrian [Eₚ(t₀)], followed by generating a number (Nᵢ) of particles, each assigned a weight (pᵢ) and corresponding to a pair of simulated trajectories for the vehicle and the pedestrian at the instant (tᵢ), and for each of which a kinematic state [Eᵥ(tᵢ) and Eₚ(tᵢ)] is simulated which is thereafter compared with the initial state,
in a case there is impact, estimating and storing characteristics of the impact, before eliminating the particle considered and continuing simulation with a following particle up to an Nᵢ^{th} particle,
in a case of an exit from the impact zone, without there having been any impact, storing characteristics of the trajectory considered before its elimination and continuation of the simulation with the following particle up to the Nᵢ^{th} particle,
in a case there is no impact, verifying the simulation has not terminated, and if the simulation has terminated without impact, storing the last trajectory and its elimination,
in a case there is no impact, the particle considered having survived, calculating the ratio (β_{i,k}) of the value of the significance (I_{i,k}) associated with its new state at the instant (tᵢ) in the state space to its value at the previous instant (tᵢ₋₁), which is thereafter compared with 1:
if the ratio β_{i,k} is equal to 1, the trajectory does not exhibit a growing interest and the method passes to a following simulated trajectory,
if the ratio β_{i,k} is less than 1, random elimination by a “Russian roulette” of the particle which is of no interest, with allocation of a new weight (pₖ) if it survives,
if the ratio β_{i,k} is greater than 1, scaledown by splitting of the particle considered to be significant into a number [n(k)] of new particles each assigned a weight, different from that of the significant particle, which particles will be processed at the following instant (tᵢ₊₁),
after verifying all the Nᵢ particles have been processed, estimating probability of impact and of characteristics of the possible impact on the basis of statistics on the weights stored.

19. A system for implementing the method of predicting impact between a vehicle and a detected moving pedestrian, carried on board the vehicle, as claimed in claim 11, comprising:
means for detecting obstacles in the environment of the vehicle that are associated with means for estimating their position and their speed and that are linked to vehicle/pedestrian impact prediction means, the prediction means additionally receiving information about dynamics of the vehicle equipped with the system on part of sensors connected to controls of the vehicle, and associating with each detected obstacle a probability of impact, a time before impact, an envisaged impact zone, and a probability of speed on impact, the information associated with each obstacle being thereafter dispatched to means for selecting an optimal counter-measure that the system must apply in an emergency to protect the pedestrian.

20. The implementation system as claimed in claim 19, wherein the impact prediction means associates with each detected obstacle an impact speed.
